(19) United States
(12) Patent Application Publication
(10) Pub. No.: US 2014/0272820 A1
(43) Pub. Date: Sep. 18, 2014

(54) LANGUAGE LEARNING ENVIRONMENT

(71) Applicant: MEDIA MOUTH INC., Salt Lake City, UT (US)

(72) Inventor: Corey Wride, Salt Lake City, UT (US)

(73) Assignee: MEDIA MOUTH INC., Salt Lake City, UT (US)

(21) Appl. No.: 13/839,917

(22) Filed: Mar. 15, 2013

(51) Int. Cl. G09B 19/06; G09B 5/04

(52) U.S. Cl. CPC G09B 19/06; G09B 5/04
USPC 434/157

(57) ABSTRACT

A method of providing a language learning environment comprises accessing media content, and identifying a number of content objects associated within the media instance. An apparatus for providing a language learning environment, comprises a processor, and a memory communicatively coupled to the processor, in which the memory comprises of metadata for the media, and in which the processor executes computer program instructions to, access media, and identify a number of content objects associated within the media instance. A computer program product for providing a language learning environment comprises a computer readable storage medium comprising computer usable program code embodied therewith, the computer usable program code comprising computer usable program code to, when executed by a processor, access media, computer usable program code to, when executed by the processor, identify a number of content objects associated within a media instance.

### BACKGROUND

Due to an increasing volume of international business, travel and communication, language learning programs are produced to help an individual learn a specific language. Language learning programs may be categorized as any type of media or combination of media such as, for example, books, magazines, internet, audio, video, and computer programs, among others. In addition, languages may be taught in a traditional classroom setting where a teacher who knows a particular language instructs students. These methods and practices of learning a language are widely accepted and practiced across the world.

The methods of learning a language as mentioned above are usually ineffective and produce very little results for the time and money an individual spends learning a language. These methods very often do not allow an individual to immerse themselves in the language, listen to native speakers, practice speaking the language, and receive feedback on their progress in an engaging course of action.

### BRIEF DESCRIPTION OF THE DRAWINGS

The accompanying drawings depict various examples of the principles described herein and are a part of the specification. The examples are given merely for illustration, and do not limit the scope of the claims.

FIG. 1A is a diagram showing a language learning system (100) comprising a language learning program downloadable to and executable on a client device, according to one example of principles described herein.

FIG. 1B is a diagram showing a language learning system (150) comprising a web-based environment of the language learning program executable in connection with a client device with an optional downloadable component for enhanced features, according to one example of principles described herein.

FIG. 2 is a diagram showing administration of the language learning program in a web-based environment, according to one example of the principles described herein.

FIG. 3 is a flowchart showing a method for assisting a user in learning a language, according to one example of the principles described herein.

FIG. 4 is a flowchart showing a method for assisting a user in learning a language, according to still another example of the principles described herein.

FIG. 5 is a diagram showing a user interface for the language learning program, according to one example of the principles described herein.

FIG. 5A is a diagram showing a user interface for the language program, according to another example of the principles described herein.

FIG. 6 is a flowchart showing a method for instantiating a user's account in the language learning program, according to one example of the principles described herein.

FIG. 7 is a diagram showing a method for extraction and storage of segment content objects from media subtitles according to one example of the principles described herein.

FIG. 8 is a diagram showing a method for extraction and storage of segment content objects from media closed captioning, according to one example of the principles described herein.

FIG. 9 is a diagram showing how user created content objects can be certified as having been created correctly, according to one example of the principles described herein.

FIG. 10 is diagram showing a method for the user to create new or modify existing segments, according to one example of the principles described herein.

FIG. 11 is a flowchart showing a method for the creation of content objects, according to one example of the principles described herein.

FIG. 12 is a flowchart showing a method for testing a user on subscribed words or phrases and seeing metrics on the results, according to one example of the principles described herein.

FIG. 13 is a flowchart showing a method for a user to receive micropayments, according to one example of the principles described herein.

FIGS. 14A and 14B are images of the content browser, showing the content browser in expanded or collapsed views respectively, according to one example of the principles described herein.

FIGS. 15A and 15B are diagrams of explicit and implicit linking respectively of content objects, according to one example of the principles described herein.

FIG. 16 is a diagram showing a recursive tree hierarchy for permission, management, and reporting purposes, according to one example of the principles described herein.

FIG. 17 is a diagram showing a user content object with metrics, according to one example of the principles described herein.

FIG. 18 is a diagram showing a method for determining whether a user can speak, recognize, or both speak and recognize a particular word or phrase that comes from a one or more segment content objects, according to one example of the principles described herein.

Throughout the drawings, identical reference numbers designate similar, but not necessarily identical, elements.

### DETAILED DESCRIPTION

The present application discloses a language learning system that uses a variety of media as the primary language learning course content. By interacting with the media such as audio, video, pictures, annotations, subtitles, and playlists, among others, users gain meaning and understanding from the scenes or segments they are consuming. Where a movie is used, for example, users can imitate their favorite actors. In other examples, users of the present systems and methods can be tested on words and phrases in context. Therefore, media such as, for example, documents available on the Internet, web pages, internet applications, peer-to-peer communication systems, audio, video, computer programs, and playlists containing links to other media, among other forms of media may be used to assist a user in more naturally learning a non-native language.

The present application discloses systems, methods, and a language learning program providing functionally to access and play media content in which a user may learn a language in an interactive environment. The present systems and methods identify and/or receive a number of content objects within the media content, and test language proficiency in comprehension, speaking, and writing based on a portion of the content objects within the media content.

A language learning program includes: a media player to play media content files such as DVD files, .mp4, .flv, .wmv, and streaming protocols such as RTIMP and RTSP among others; a network connection for providing a downloadable or network-based version of a language learning program; a language learning program to identify and/or receive a number of content objects within the media content comprising associations of movies, music, phrases, phrase lists, chats, translations, users, persons associated with the media, audio, videos, segment tracks, word segments, objectives, and lessons, among others. The language learning program also tests language proficiency using techniques such as, for example, matching of phrases, typing phrases spoken in media, selecting words or phrases from a list, creating audio content objects to mimic media segments, community rating and testing of audio objects, and voice recognition of audio objects, among others.

A computer program product for providing a language learning environment is also described herein. A computer readable storage medium comprising computer-usable program code embodied therewith may access media and identify a number of content objects associated within a media instance.

As mentioned above, due to an increasing volume of international travel and communication, language learning programs are produced to help an individual learn a specific language. Language learning programs may be categorized as any type of media or combination of media such as, books, magazines, internee, audio, or video. In addition, languages may be taught in a traditional classroom setting where a teacher, who knows a particular language, instructs students. These methods of learning a language are widely accepted and practiced across the world. However, these methods of learning a language are usually ineffective and produce very little results for the time and money an individual spends learning a language. These methods do not allow an individual to immerse themselves in the language, listen to native speakers, practice, repeat phrases, slow down the conversation, and receive constant feedback on their progress in an engaging process.

A language learning program may be implemented in which a user may immerse him or herself in a language using a media player embedded in a learner management system to access media that would be of interest to the user in order to learn certain words in a desired language. The native language and the desired language to be learned are set forth by the user. For example, the user's native language may be Spanish, but the user may wish to learn English. The user selects the native language of Spanish and the desired language to be learned as English. Any number of languages may be learned by the user through the use of the present systems and methods.

Additionally, the user may desire to subscribe to a number of words, phrases, phrase lists, scenes, or individual segments contained in the media and a proficiency test may be given to evaluate the user's progress. Thus, a user may learn a language by accessing content they want to view, based on the words, phrases, or functions they want to learn. Further, the user may be tested in an interactive method by transcribing, selecting words or phrases from a list, and imitating words and phrases contained within the accessed media.

As used in the present specification and in the appended claims, the “media” is meant to be understood broadly as any form of data that can be rendered within a media player on a computing device. For example, media may include, but is not limited to, graphics, images, text, audio, and video, among other forms of computer-rendered data. Further, media may be a combination of the forgoing. Media may take the form of, but is not limited to, DVD files, .avi, .mp4, .flv, .wmv, and implementations of streaming protocols such as RTMP and RTSP, among others.

As used in the present specification and in the appended claims, the term “language learning program” is meant to be understood broadly as any program environment in which a language may be learned. In one example described herein, the language learning program environment is presented to a language learner in the form of a computer-implemented language learning system. In this example, the computer-implemented language learning system may be a standalone system, a system implemented over a network, a system presented as a website rendered in a web browser with an installed plug-in, or combinations thereof.

As used in the present specification and in the appended claims, the term “player” is meant to be understood broadly as any media player for multimedia with or without a user interface. As depicted, the player with its corresponding codecs, decoders, filters, and library files may be installed locally on a client device or installed over a network, such as the World Wide Web. Additionally, the core player may be written in C++ or other programming languages, and may use other technologies such as DIRECTSHOW developed and distributed by Microsoft Corporation, ActiveX also developed and sold by Microsoft Corporation, or other plug-in and media rendering technology.

The player includes of a number of methods that can be called or properties that can be set by user interface controls, such as, for example, controls to present a full screen, a progress bar, controls to adjust play speed, controls to repeat a segment, controls to change audio files, closed captioning controls, and subtitles, among many other playback controls. Player controls give the user the ability to manipulate the playback of the media. The player also includes a number of processes that execute when a specific action has been taken or when something happens, such as when a DVD is inserted into a computer, or a movie stops playing. Additionally, the player may exhibit frame accuracy for play, pause, and stop and a look ahead to render upcoming media. Further, the core player may read any format of media such as, for example, DVD files, .avi, .mp4, .flv, .wmv, and streaming files, such as, RTMP, and RTSP, among others. Depending on the media format required, downloading and installation of dependencies such as codex and related libraries allows the media to be recognized and played by the core player.

The player may also render “virtual media” in the form of different media formats linked together in a playlist. For example, the player may open a playlist of three distinct media files and play portions of each media file as specified in the playlist in the designated order. Such a playlist may also contain commands to call a particular method or set a particular property, such as, for example, muting the audio or pausing the movie. The playlist, therefore, contains an ordered set of any number of commands that the user might do if the user were manually manipulating the media rendered by the player. It could, for example, instruct the player to open a media file, play for a period of time, repeat any number of segments, and show annotations at a given moment in time.

As used in the present specification and in the appended claims, the term “segment” is meant to be understood broadly as a moment in time from a start time to a stop time within the media, and may include text to identify words uttered during time interval. Boundaries of segments may be determined by, for example, media subtitles, closed captioning, user defined values, or subtitle files loaded into the system, among others. Segments within the media may be used to assist a user in learning a target language. For example, segments may be used in matching words with audio heard within the media, during an AB repeat function which repeats a segment within the media at a normal or slowed speed, while skipping forwards or backwards between longer segments within the media, or a comparison of user recorded voice with audio files from a specific segment within the media.

As used in the present specification and in the appended claims, the term “content object” is meant to be understood broadly as any form of data that may be integrated into or utilized within the language learning program's environment. Examples of content objects may include, but are not limited to segments, movie descriptions, music descriptions, annotations, phrases, phrase lists, chats, translations, users of the language learning program, persons associated with the media (such as actors, producers, directors), audio, video, segment tracks, word segments, and lessons, among others.

Further, all content objects have states of existence depending on the context in which it is either used or viewed or its relationship to the user. For example, a content object state may be in a “subscribed” state if the user has indicated that he or she wants to be tested on a particular word, phrase, phrase list, scene, or segment. When the user enters a test mode, content they are subscribed to will appear in a “test mode” state. A test mode state may not show all the data associated with the content object, but may require the user to supply the missing information. For example, a segment content object rendered in “test mode” may not include the text spoken, but, by playing the segment (based on the media, start, and stop times), the user may be prompted to type or select from a list the actual text spoken.

A content object state also depends on how and where the content object is rendered on a display screen. For example, a content object may be the focus of attention and be rendered in a “spotlight” state with all of the information visible, with related or linked content objects appearing underneath in an abbreviated, or in a “collapsed” view with limited data. Users may be able to modify the current state or view of a content object, such as, for example expanding a “collapsed” content object to show more information. Additional states may include edit mode, read-only state, and reduced state, among others. Further, all content objects comprise a name, a language, ratings from program users, an action (such as delete, block, subscribe, set default version), an editable capability, a media location link, and data fields specific to that content object, among others. A content object may comprise elements such as a movie scene, translations, or cultural context relevant to a specific part of the media. Learning occurs by first identifying content objects and then viewing, editing, or commenting on them and their relationship to the media.

Additionally, content objects may be linked explicitly or implicitly to any number of other content objects. Any content object may have a relationship with any other content object explicitly and/or implicitly. Explicit linking is the creation of a relationship between two content objects with a definition of the relationship between them. For example, a movie description content object may be named “Finding Nem©” to represent information about the movie. This content object may have at least location data field representing the physical location of the media—such as a file, DVD drive, or streaming location from the Internet. A person content object named “Albert Brookes” may exist with an explicit link to the “Finding Nemo” movie description with the relationship defined as an “actor” in the movie. Additionally, a segment track content object named “Finding Nemo Subtitles in Arabic” may contain alternate segments or subtitles for the movie in a different language. The “Finding Nemo Subtitles in Arabic” content object can be explicitly linked to the “Finding Nemo” movie content object enabling anyone who browses its content object to see the option of also viewing the subtitles in Arabic. Likewise, a user may decide to comment on the “Finding Nemo” movie—or any other content object—and these comments are stored as content objects with an explicit link to the “Finding Nemo” movie.

In one example, the number, quality, and authorship of explicitly linked content objects may increase the ranking, visibility, and importance of the content objects they are linked to. These explicitly linked content objects can be rendered in an abbreviated state when the objects they are linked to are displayed. Another type of explicit linking could be the creation of an audio content object that was created while playing a media segment. The audio object may inherit the segment length and text of the media segment, and can be marked as a user's imitation of the media segment. These two content objects, once linked explicitly, are considered explicitly linked.

Implicit linking is the detection of a relationship between a first content object with a second content object based on identical or similar words in the name of each object. These two content objects, once linked implicitly in this manner, are considered implicitly linked. Changing the name or tagging of one object may remove the implicit link between it and another object while simultaneously linking it with one more other objects. For example, a phrase content object named “I love you” will be implicitly linked with a movie content object named “I Love You Phillip Morris”, a comment content object named “I love you” and a translation content object also named “I love you” that contains the phrase meaning in other languages. The implicit link between object names and tags is detected by the language program so that a user can understand the various uses and contexts of an individual word or phrase without relying on explicit linking. One embodiment of this implicit linking is the automatic formatting of segment content objects when they appear as annotations during media playback. For example, as media is playing, annotations such as segment content objects may appear in much the same way that subtitles appear for movies. These annotations may contain text, images, and other information, but the text can be formatted to show the implicit linking for other content objects in the system. If a segment annotation appears with the text “Baby, I think I love you”, the latter phrase “I love you” can be underlined or formatted such that when the user clicks or hovers over the text, references to the translation “I love you” for a particular language, the “I Love You Phillip Morris” movie, and comment content objects by users in the system where they said “I love you” may be presented to the user. Implicit linking allows users to detect usage of words and phrases across a variety of content objects without requiring any explicit linking between them. This enables media played for the first time to be linked automatically by the words and phrases contained therein.

In one example, an administrator or user is avowed to add content to the language learning program's environment. The added content is linked explicitly or implicitly according to rides derived in the language learning program, making the added content itself, a content object. In one example, content objects may be auto-created when a media instance is first presented within the system such as when the media instance is viewed or played and subtitles or closed captioning information is detected and loaded into the database as segment content objects, containing a start time, end time, and text to display. Content objects can be reused, modified, and versioned. For example, if a user modifies an existing content object they do not have rights to, another version of the content object is created. This additional version of the content objet may, at some point, become the default version to be displayed. The data and fields in content objects can be modified, added, deleted and new types of content objects can be created. An content objects inherit similar features and functionality such as permissions, ratings, actions, and different states such as “test mode.” Additionally, in one example, content objects are consistent in form and function by visually looking similar throughout the language learning program and comprising common features. The differences between content object types are derived from the different data fields they contain.

As used in the present specification and in the appended claims, the term “annotation” is meant to be understood broadly as content objects that appear at a point in time while media is being rendered, and may be for user interaction. Annotations may include, but are not limited to, segments, comments, or content objects such as words, phrases, definitions, images, uniform resource locators (URLs), subtitles, dosed captioning, lessons, groups, scenes, audio files, comments, chats, and persons, among others. For example, at a particular moment in a movie, a number of annotations may be presented to a user that prompts the user to take a quiz on what is happening, displays the subtitle text in a different language, or prompts the user to click on a link with additional information.

As used in the present specification and in the appended claims, the term “phrase” is meant to be understood broadly as one or more words standing together as a conceptual unit, typically forming a component of a clause. In one example, a phrase may refer to a single word. In another example, a phrase may refer to a number of words forming a complete sentence or a portion of a sentence.

Further, as used in the present specification amid in the appended claims, the term “a number of” or similar language is meant to be understood broadly as any positive number comprising 1 to infinity; zero not being a number, but the absence of a number.

Aspects of the present specification may be embodied as a system, method, or computer program product. Accordingly, aspects of the present specification may take the form of hardware or a combination of hardware and software. Furthermore, aspects of the present specification may take the form of a computer program product embodied in a number of computer readable mediums having computer readable program code embodied thereon.

Any combination of computer readable medium(s) may be utilized. A computer readable storage medium may be, for example, but is not limited to, an electronic, magnetic, optical electromagnetic, infrared, or semiconductor system, apparatus, or device or any suitable combination of the foregoing. More specific examples of the computer readable mediums may include the following: an electrical connection having a number of wires, a portable computer diskette, a hard disk, a random access memory (RAM), a read-only memory (ROM), an erasable programmable read-only memory (EPROP or Flash memory), a portable compact disk read-only memory (CD-ROM), an optical storage device, a magnetic storage device, and any suitable combination of the foregoing, among others. In the context of this document, a computer readable storage medium may be any tangible medium that can contain, or store a program for use by or in connection with any instruction execution system, apparatus, or device such as, for example, a processor. In another example, the computer readable medium may be a non-transitory computer readable medium.

Program code embodied on a computer readable medium may be transmitted using any appropriate medium, including but not limited to wireless, wire line, optical fiber cable, RF, etc., or any suitable combination of the foregoing. Computer program code for carrying out operations of the present specification may be written in an object oriented programming language such as Java, C++, or C#, among others. However, the computer program code for carrying out operations of the present systems and methods may also be written in procedural programming languages, such as, for example, the “C” programming language or similar programming languages or scripting languages such as “JavaScript.” The program code may execute entirely on the user's computer, partly on the user's computer, as a stand-alone software package, partly on the user's computer and partly on a remote computer or entirely on the remote computer or server.

In the latter scenarios, the remote computer may be connected to the user's computer through a local area network (LAN) or a wide area network (WAN), or the connection may be made to an external computer via, for example, the Internet using an Internet service provider.

Flowcharts and/or block diagrams of methods, apparatus, and computer program products are disclosed. Each block of the flowcharts and/or block diagrams, and combinations of blocks in the flowcharts and/or block diagrams, can be implemented by computer program instructions. These computer program instructions may be provided to a processor or other programmable data processing apparatus to produce a machine, such that the instructions, which execute via a processor of the computer or other programmable data processing apparatus, implement the functions/acts specified in the flowchart and/or block diagram block or blocks.

In one example, these computer program instructions may be stored in a computer-readable memory that can direct a computer or other programmable data processing apparatus to function in a particular manner, such that the instructions stored in the computer-readable memory implement the functions/act specified in the flowchart and/or block diagram blocks or blocks.

The computer program instructions may also be loaded onto a computer or other programmable data processing apparatus to cause a series of operations to be performed on the computer or other programmable apparatus to produce a computer-implemented process such that the instructions which execute on the computer or other programmable apparatus implement the functions/acts specified in the flowchart and/or block diagram blocks or blocks.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

Further, in the following description, for purposes of explanation, a user or other individual may interact with a number of computing devices, systems, or programs. By so doing, the user may manipulate a number of user-selectable parameters, which, in turn, cause the computing devices, systems, or programs to carry out one or more processes within the computing devices, systems, or programs. Therefore, manipulation or use of the computing devices, systems, or programs by a user is meant to include the execution of one or more processes within the computing devices, systems, or programs.

Referring now to the figures, FIG. 1A is a diagram showing a language learning system (100) comprising a language learning program downloadable to and executable on a client device (108), according to one example of the principles described herein. In one example, a downloadable version of the language learning program may be downloaded to a client device (108). The language learning program comprises a core player (102), business logic (104), and utilizes memory (110), and a processor (106) of the client device (108) to perform the functions described herein. The core player (102) provides functionality to the program to read media. The core player (102) also allows the user to interact with the media's annotations to learn a language. A local database cache (137) is associated with the core player (102) from which the core player (102) can obtain data relating to media instances rendered within the system (100). Business logic (104) provides the program basic function. Business logic may include, but is not limited to, logic associated with the managing of fees, processing payment, tracking the progress of a user's language proficiency, subscription information, content object data, relationships between content objects, indexing, and voice recognition, among others. The processor (106) executes routines and processes source code to give the program and its components functionality.

The memory (110) stores data, program files, or media files for use by the processor (106) and the language learning program. Memory (110) may take the form of, but is not limited to, an electronic, magnetic, optical, electromagnetic, infrared, or semiconductor system, apparatus, device, or propagation medium. More specific examples (a non-exhaustive list) of the memory would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any combination thereof, among others. In one example, the memory (110) comprises RAM (114), ROM (116), a hard disk drive (HDD) (118), a DVD drive (120) a compact disk (CD) drive (122), or any combination thereof, among others. Additionally, data, such as program files or media files, may be stored externally on an external storage (126) device.

Further still, a user may access data files (112) containing metadata linking content objects, such as movie titles with phrases, lessons, and segments, among others, to other media containing similar content. The data files (112) may be stored on the client device itself or may be accessed over a network, such as, for example, an intranet, an internet, the World Wide Web, or the Internet, using a network adapter (124). Data files (112) may contain metadata, language learning program updates, media files, codex, libraries, or any combination thereof which provides functionality for the language learning program to operate on the client device (108).

In one example, the user may desire to interact with the language learning program contained on the client device (108). The user may do so by means of a user interface (140) (UI) and by using input/output (I/O) devices such as, a mouse (130), a display (132), a keyboard (134), or audio in and out devices (135) such as a microphone, earphones, or speakers. Further, peripheral adapters (128) may be used to support parallel I/O interfacing capability for microprocessor systems.

FIG. 1A depicts various examples for installing the language learning program. In one example, the language learning program is contained on a Compact disk (CD) or DVD disk. The user inserts the disk into the CD drive (122) or DVD drive (120) upon which the user is prompted to install the necessary files, such as, the core player (102) and business logic (104). These files are stored, in part or whole, on the client device's (108) HDD (118), RAM (114), ROM (116), external storage (126) device, or any combination thereof.

In another example, the language learning program may be made available for download via a network connection and the network adaptor (124). In this example, a server may store the language learning program, and make the language learning program available for download by a customer or user of the language learning program.

Once the core player (102) and the business logic (104) file are installed, the user may use the I/O devices, such as, a mouse (130), a display (132), keyboard (134), and audio in and audio out (135) devices such as microphone, speakers, or headphones to interact with the language learning program. The core player (102) accesses media when a user inserts a DVD in the DVD drive (120), inserts a CD into a CD drive (122), or uses media files contained on a HDD (118) or external storage device (126).

In another example, the user may access media over a network, such as, for example, an intranet, an internet, the World Wide Web, or the Internet, using the network adapter (124) where the media data files may be stored on a server. The client device (108) sends a request to the server containing the media data files where the request is received. The server containing the media data files sends the media data back where it is received by the client device (108). In this example, a number of files such as, the core player (102) and business logic (104) are installed on the client device (108) and are used to give the language learning program functionality in which the language learning program may access media on a number of servers such as servers hosting and making available the media of the YOUTUBE video-sharing website, NETFLIX media streaming services, or HULU media streaming services, among others.

FIG. 1B is a diagram showing a language learning system (150) comprising a web based system of the language learning program executable in connection with a client device (108), according to one example of principles described herein. According to one example, a web based version of the language learning program includes a core player (102) installed on a client device (108). The client device (108) has memory (110), and a processor (106) to provide functionality to the core player (102) to read media, allowing the user to interact with annotations and content objects associated with the media to learn a language as described below in connection with FIG. 4. A local database cache (137) is associated with the core player (102) from which the core player (102) can obtain data relating to media instances rendered within the system (100). A web browser user interface (136) is installed on the client's device (108) to allow the user to access an application server (138) using the network adapter (124) and to use business logic (104) and gain access to the database (140) files. As noted above, business logic (104) gives the program functionality. Business logic (104) may be stored, for example, on the application server (138) and may include, but is not limited to: management of fees, processing payment, tracking the progress of a user's language proficiency, subscription information, content object data, relationships between content objects, indexing, and voice recognition, among others.

In various examples of FIG. 1B a user accesses a network, such as the World Wide Web, using a web browser user interface (136) contained on a client device (108). Using a web browser user interface (136), a user downloads a core player (102) from an application server (108) to a client device (108). In keeping with the given example, the user logs into the language learning program. By logging into the language learning program, the user can interact with the player to consume media with annotations (102), or perform transactions on the application server (138) according to the business logic (104), among other activities. Further, the business logic (104) is used to load the correct user settings for a particular user. As noted above, the client device, using the network adapter (124), may access the database's (140) data files stored on an application server (138). The client device (108) will send a request to the application server (138) which contains the data files in a database (140) and will send the data back where it is received by the client device (108). The user may use the I/O devices, such as, a mouse (130), a display (132), keyboard (134), and audio in and audio out (135) devices such as microphone, speakers, or headphones to interact with the language learning program. The core player (102) accesses media when a user inserts a DVD into the DVD drive (120), inserts a CD into a CD drive (122), or uses media files contained on a HDD (118) or external storage device (126). Further, media may be accessed over a network connection, using the network adapter (124), to stream video from a network such as a local area network or the Internet.

FIG. 2 is a diagram showing administration of the language learning program in a web-based environment, according to one example of principles described herein. FIG. 2 shows one embodiment of the system shown in FIG. 1B. In addition to FIG. 1B, FIG. 2 shows an administrator device, (201) comprising memory (220) and a processor (221). The administrator device (201) is used to configure the application server's (202) processor (211), business logic (213), memory (210), and database (212). The database (212) may take the form of portions of HDD (214), RAM (215), ROM (216). As noted above, business logic may include, but is not limited to, managing subscription fees, processing payment, tracking the progress of a user's language proficiency, subscription information, content object data, relationships between content objects, indexing, or voice recognition, among others. In one example, the administrator device (201) may restrict user activity and grant or deny access to data or parts of the system. The administrator device (201) may also update certain processes of business logic (213) or may update the database (212) The administrator device (201) may be operated remotely or on a server, may have the same functionality as the client devices (204-1, 204-2, 204-n), and may or may not contain additional program functionality. The application server (202) and the client devices (204-1, 204-2, 204-n) act as a client-server application. The client devices (204-1, 204-2, 204-n), contain memory and a processor. Further, memory on the client devices (204-1, 204-2, 204-n) may comprise RAM (FIG. 1B, 114), ROM (FIG. 1B, 116), a hard disk drive (HOD) (FIG. 13, 118), a DVD drive (FIG. 13, 120), or a CD drive (FIG. 1B, 122) to provide functionality or media for the core player (FIG. 1B 102). The client devices (204-1, 204-2, 204-n) may further send a number of requests to the application server (202) for access to the core player (FIG. 2, 102) for use or download, access to the business logic (104) for use or download, and access to data representing media.

The application server (202) will receive the client device (204-1, 204-2, 204-n) request. The application server (202) may access the memory (210), database (212), business logic (213) or any combination thereof, and process the request using a processor (211). The information is then sent from the application server (202) to the client device (204-1, 204-2, 204-n) where the information may be stored in memory and executed by a processor. The information may be displayed to the client device (204-1, 204-2, 204-n) via a display monitor or by the use of speakers. Additionally, it should be noted that the client devices (204-1, 204-2, 204-n), represent a number of systems which may access the application server (202). Further, a client device (204-1, 204-2, 204-n) may consist of a computer, laptop (204-1), tablet (204-2), or smart phone (204-n) among others, as depicted in the figures.

In various examples of FIG. 2, the administrator device (201) may update a business logic (213) process on the application server (202). The administrator device (201) accesses the application server (202), and makes any required updates to the business logic (213). The updates are processed by a processor (211) and stored in memory (210) on the application server (202). Memory may include a portion of a HOD (214), RAM (215), or ROM (216). Further, a client device (204-1, 204-2, 204-n) may send a business logic request to the application server (202). The application server (202) retrieves the newly updated business logic (213) which is sent to the client device (204-1, 204-2, 204-n), processed by a processor, and stored in memory on each client device (204-1, 204-2, 204-n). Thus, the business logic (213) on the client device (204-1, 204-2, 204-n) is updated.

In another example of FIG. 2, the administrator device (201) may request that the database (212) containing data files on the application server (202) be updated. The administrator device (201) accesses the application server (202), makes any required updates to the database's (212) data files. The updates are processed by a processor (211) and stored in memory (210) on the application server (202). Further, the client device (204-1, 204-2, 204-n) sends a request to the application server (202) to receive current data files from the database (212). The application server (202) retrieves the newly updated data files from the database (212) which are sent to the client device (204-1, 204-2, 204-n), processed by a processor, and stored in memory on each client device (204-1, 204-2, 204-n). Thus, the business logic (213) on the client device (204-1, 204-2, 204-n) is updated.

FIG. 3 is a flowchart showing a method for assisting a user in learning a language, according to one example of principles described herein. In one example, the method comprises accessing (block 301) media content. In one example, the language learning program, after being directed by a user, accesses media content stored in, for example, RAM (114), ROM (116), HOD (118), a DVD being read in the DVD drive (120), a CD being read in the CD drive (122), external storage (FIG. 1A, 126), or any combination thereof, among others, as described in connection with FIG. 1A and FIG. 1B.

The user or the system (100, 150, 200) identifies (block 302) a number of content objects associated in the media instance. These content objects may be objects explicitly linked to the media's content object, or may be annotations that appear while rendering the media. A user identifies or receives a content object by selecting media from memory or creating a content object through explicit or implicit linking. The system (100, 150, 200) may automatically identify a number of content objects when presented with media from which the system may derive content object. As described above, media may take the form of DVD files, .avi, .mp4, .flv, .wmv, and streaming files, such as, RTMP, and RTSP. Within the media, a number of content objects are identified (block 302). Content objects may take the form of relational explicit or implicit linking as demonstrated in FIG. 15A and FIG. 15B, to include, but not limited to, user comments, lessons, groups, actors, or scenes. Further detail is described in connection with FIG. 15A and FIG. 15B below.

In one example of FIG. 3, the user may then interact (block 303) with the content objects identified such as annotations that may appear while the media is rendered. Interaction with content objects can mean, but is not limited to, reading the information contained therein, repeating (such as in the case of a segment content object), or rendering of the object a number of times. Repeating a segment multiple times may include modifying the play speed or changing the language for the segment or subtitle track as well as the audio track. Interaction with content objects may also comprise performing an action on the content object, such as subscribing to the content object to be tested on the content object later, deleting the content object, or editing the content object. One example of how a user may edit a segment content object is adjusting the text, start time, or end time of the segment content object.

In another example, a segment content object may have been auto-created by converting subtitle information into segments. In the cases where the text did not exactly match what was spoken in the movie, the user can interact with the object by editing the text and give the content object the correct value. Likewise, the user can adjust the start and stop time of a segment.

In one example of FIG. 3, the user may provide media of interest in order to learn words and phrases associated with that type of media. The media content accessed (301) may be a fantasy about dragons, for example. As the fantasy media plays, content objects (302) such as, for example, actors in the movie may appear as annotations or in other ways for the user to interact with (303). Words such as spells and potions may be repeated, comments from other users about trivia may be appended, and scenes where the movie was filmed may be identified, among other forms of content objects. The user may interact with these various content objects to learn, for example, additional information about dragons in the language the user chooses to study.

In another example of FIG. 3, the user may decide to create new content objects as metadata to the annotations or content objects identified (302). Because these content objects were created in the process of interacting with another content object (303), they are created with an explicit link defining their relationship. For example, a user may comment on a content object they are interacting with (303), and that comment becomes its own content object that others can read, rate, and benefit from. In another example, a user who is interacting with a segment content object by repeating it over and over again can create an audio content object by recording his or her voice in sync with the segment being repeated. The creation of new content objects such as audio recordings is a beneficial tool for language education. These content objects such as audio recordings can be measured and, if they pass certification, serve to increase a user's score and standing within the language learning program.

In one example, the method may comprises receiving (block 302) a number of identified content objects, and identifying (block 302) a number of content objects associated with a media instance. As described above, content objects may take the form of relational explicit or implicit linking as described in connection with FIG. 15A and FIG. 15B below.

In one example, a teacher may provide a student with a number of phrase lists to be learned for a learning session. These phrase lists may comprise greetings, colors, apologies, among other phrase lists with various subjects or topics. In one example, the student may desire to learn about colors. The student selects a number of colors they desire to learn. Thus, the language learning program will analyze and identify (block 302) a number of content objects associated with colors. The language learning program will then identify (block 302) a number of content objects about color associated with a media instance. The media player will play a number of segments from the media in which the user may interact with the content objects and learn about the phrases; in this example, about colors.

FIG. 4 is a flowchart showing a method for assisting a user in learning a language, according to still another example of principles described herein. In the example of FIG. 4, the method comprises the system allowing access (block 401) to the language learning program when a user provides credential such as, for example, a username and password. All the users' settings are loaded, which may comprise, for example, user's native language, user progress, and learned words. Media is accessed (block 402) by the system either automatically or upon receiving instructions from a user as described above in connection with FIG. 3, or a number of content objects are selected (block 403) from a list, such as a phrase list content object or by user searches, or results from implicit linking. Playback may be manipulated (block 404) in response to manipulation of the playback controls by a user in order perform tasks such as repeating scenes, sections, and segments of a movie as well as modifying the play speed and changing the audio, segment or subtitle tracks. A number of annotations such as images, words, and subtitles, among others, may be presented (block 405) in the media. The annotations are presented (block 405) for selection by the user in the media to display additional content related to words or phrases, such as, for example, a definition in the native language of the user. Content objects that are displayed may then be interacted with (303) and may also contain explicit or implicit links to additional content objects as metadata, and these content objects may be selected and interacted with (303) in the same way. Interaction (block 303) with content objects may include, for example, reading annotations or selecting a content object to be rendered, among other forms of content object interaction. The process of selecting and interacting with content objects may be navigated by the user any number of times to access any number of different types of content objects with any level of association with an initial object.

A number of content objects may be subscribed to (block 406) for testing upon selection by the user of those content objects and an indication by such selection that those content objects are to be subscribed to. The system may then present (block 407) a test mode, in which content objects are rendered in a different state such as “test mode” where a number of tests are performed (block 408) on user's language understanding and mastery of a number of subscribed-to content objects. Testing of words or phrases may include; matching words or phrase, typing words or phrases, creating a new content object by recording the user's voice as an audio recording, among others, and combinations thereof. Feedback may be provided to the user in the form of a list with ratings as described in connection with FIG. 17 and FIG. 18 described in more detail below.

In another example of FIG. 4, the system logs (block 401) a user into the language learning program. In this example, the media accessed (block 402) may be a film about cowboys. Playback of the media is manipulated (block 404) such as, play, pause, repeat, next chapter, previous chapter, stop, etc upon manipulation of the playback controls by a user. With these controls, the user may watch the whole movie or choose certain segments of the movie. As the segments of the movie are played, annotations corresponding to each segment of the movie are presented (block 405) by the system for user interaction.

For example, the phrase “Never approach a bull from the front, a horse from the rear, or a fool from any direction” may be spoken in this cowboy movie, and subtitles for this phrase may appear on the display (132) of the user's device. The user may not understand the words, “bull,” “horse,” or “fool,” Therefore, additional content objects related to these words may be presented when user selects annotations for these words that are presented (block 405) to the user. For example, if the user selects the word “fool,” the translation content object of “fool” may be displayed showing the meaning in the native language of the user. Further, a definition, image, or a URL may also be provided to the user to help the user further understand the word “fool.” Additionally, other information may be displayed about the word “fool” to the user. This may comprise, for example, person content objects of actors saying “fool,” movies about “fools,” or the origin of the word “fool,” among others. The user may decide “fool” is a good word to remember. The word “fool” may be subscribed to (block 406) for testing in the future.

When a number of words or phrases have been subscribed to, the test mode may be presented (block 407) to the user. A number of subscribed phrases are presented to the user for testing (block 408). In this example, a segment containing the word “fool” is played from the media. The user can modify the play speed to slow the media down, and repeat the media a number of times. The user may be given the opportunity to transcribe what he or she hears to prove that he or she can correctly recognize the words presented in the segment. The user may also be presented with a list of possible text for the segment for the user to choose from. Test mode will be described in further detail with connection with FIG. 12.

FIG. 5 is a diagram showing a graphical user interface (500) for the language learning program, according to one example of principles described herein. The graphical user interface (GUI) consists of three main parts, namely, the content browser (501), contextual guide (535), and a player panel (534). Although a number of elements are depicted in the GUI (500) of FIG. 5, more or less elements may be incorporated therein to provide less or more functionality. FIG. 5 is an example of what number and types of elements may be present in the GUI (500).

Above the content browser (501), the user may exit the program via the logout button (502). If the user desires help with any operation or topic defined within the language learning program, a help (503) button is available for the user to search a number of topics of interest to better understand the functions contained within the language learning program. A settings button (504) is available for the user to switch between different settings such as, for example, contact information, account settings, subscription plans, billing information, and password recovery, among other settings. Further, under account settings, information such as, for example, password, password confirmation, native language, learning language, country of interest, preferred media player, and default dictionaries, among others, may be selected to better suit a user in learning and understanding a language. Additionally, under subscription plans, a number of options may be selected such as, for example, a basic subscription which comprises a plan summary, benefits, and rates, or a premium subscription which comprises a plan summary, benefits, and rates. The user may also select a test button (505) that toggles the test setting on or off. Further, the user may desire to search the contents contained in the program via the search box (506), such as movies, descriptions, and themes, among other content. When a user enters search key words or filters (506), the content browser can be regenerated, but with a subset of data that corresponds only to the search performed. Searches can be across all types of content objects, or constrained to a set of determined content types.

The content browser (501) contains an add content dropdown box (507), and a non-exhaustive list of content object types, organized by tabs such as, a movie tab (508), video tab (509), music tab (510), user tab (511), phrase tab (512), audio tab (513), and a segment tab (514). These tabs may be ordered by type, may be dynamic in nature, and may be user-definable and vary from user to user. Additionally, a number of tabs may be ordered differently depending on the user's preference and a number of tabs may or may not be included in the content browser (501) panel for each user. The add content dropdown tab (507) allows the user to add a number of new content objects without any explicit linking. The movie tab (508), video tab (509), and music tab (510) include a number of content objects describing movies, videos, and music, respectively, which are displayed in a paged list (541) as described in connection with FIG. 14A and FIG. 14B. The user may select a number of movies, videos, and music content objects to read about, and interact with, and for those that have associated media locations, to be played. Further, movies, videos, and music may be sorted and categorized in a number of ways such as, for example, rating, length, views, content, and date, among others.

A user tab (511) is also provided in which the user may view a number of other users in the system. Users are also content objects which inherit much of the same functionality inherent to all content objects such as explicit and implicit linking. In one example, the user tab (511) may order a number of users according to relevance, name, relationship to the current user, or location, among other criteria. In some cases, a first user may interact more with a second user. Consequently, the second user is more relevant than other users within the present system. Thus, the second user's information may appear more frequently when the first user is logged in. A phrase tab (512) is provided showing a user the different phrases, ordered first by those that that user has subscribed to. The phrases may also contain and be sorted by ratings or by how well the user understood the phrase or word.

An audio tab (513) is also provided, and contains audio recordings of all users of the program saying various words or phrase alone or in conjunction with a media segment. As with all content objects, audio objects in the audio tab (513) may also contain ratings for how well the user understood the phrase or word. Audio objects that have been certified as having been spoken correctly drive metrics and scoring as described in connection with FIG. 17 and FIG. 18. For example, if a user creates an audio object saying “here comes the bride” and the audio object is certified as having been spoken correctly, then each individual word and phrase contained in the audio file (“here”, “comes”, “the”, and “bride”) can all be assigned a user state of “can-speak”. The certification of content objects such as audio recordings will be described in FIG. 9.

A segment tab (514) is also displayed to provide, when selected by the user, a number of segments to the user. The list of segments returned may be constrained by scope settings. For example, a user may have access to only a single DVD, and so have set the scope of content they have access to as being segments created by or contained within that DVD medium. In this example, the segments tab will not return a paged list of all segments system-wide, but only those segments that reside within the scope of the media they have access to or to which they are associated. Scope settings can set for one or more media items, or their corresponding content objects. As with all content objects in the content browser, the results can be constrained by filters and search criteria (506). In one example, a user may desire to learn the phrase, “let's get out of here!” and type that exact phrase in the search box (506). The list of paged segments in the segment tab (514) will then show several segments from movie scenes using the phrase “let's get out of here!”. Thus, a user may select a number of scenes to listen to actors saying “let's get out of here!” to see how the phrase is used in various ways and contexts. Furthermore, because segment content objects can identify the movie they may have been taken from or to which they are associated, users of the system can chose which movies they prefer to learn from.

Under the movie tab (508) in the content browser (501) a number of movie content objects (515-1, 515-2, 515-n) may appear. The movies may be listed in an order or grouping such as, for example, recently viewed, new releases, media type, and genre, among others. Movie content objects (515-1, 515-2, 515-n) may be displayed in a “reduced” state with limited information, including such details as; titles, pictures, a short description of the movie, and movie ratings for a number of movies. In one example, the movie ratings comprise generic movie ratings such as, G, PG, PG-13, and R. Further, short descriptions of the movies may comprise, for example, a plot summary, actors, a release date, a genre, among other descriptions. As with all content objects, the exact data displayed in the content objects depends on its current state, which, for the content browser (501), may be abbreviated. As with all tabs (509, 510, 511, 512, 513, 514, et cetera), the movie tab (508) displayed in FIG. 5 may include next (541-1) and previous (541-2) buttons that allow the user to navigate and page through a number of content objects (515-1, 515-2, 515-n) that can't all be displayed at once.

The contextual guide (535) displays a content display area (527) that displays a content object rendered by its state and type. Content objects may be rendered in a “spotlight” state indicating that they are the current focus of the users' attention and so hence may contain in-depth information such as, for example, a movie title a movie picture, and movie description. The actual data depends on the content object type and state. Content objects have an action drop down list (526) that is presented to a user to allow the user to subscribe to, delete, block, or share content, or perform any other number of actions. All content objects also have a ratings control (523) which allows users to both see the average rating, number of ratings, and to rate the content object themselves. The movie content object, for example, may comprise, but is not limited to, a plot summary, a number of actors within the movie, a release date, and a genre, among others.

A content object rendered in the “spotlight” state (519) in the contextual guide (535) also includes a media location dropdown box (522) which allows the user specify, select, add, or edit the location of the selected media. For example, if the content object (527) displayed is rendered in a “spotlight” state with all its data. Some of the data included is all the media locations where that movie/title/music can be played. The media location (522) can be, for example, a DVD drive, a file, and a URL, can come from the application server (202) as a location common to all users, or can come from a local database cache (137) within the player (102) that is unique to just that user's personal computer. For instance, there may be local files a user has for media, but is not shared with others.

Further, an add content dropdown box (524) allows users to add additional content that will be related with an explicit link to the main content object in the “spotlight” state. The add content dropdown box (524) is similar to the add content dropdown box (507) but differs in that the newly created content object will also serve as metadata and an explicit link will be created. In one example, content added by the add content dropdown (524) may be in the form of a comment, a list of which constitutes a chat in which a user may scroll through the history of the comments made, and leave comments when other users are offline, the comments acting as a conversation thread. In another example, the user may chat live with other users when those users are online. Additionally, chat may be used as a searchable content object which has private and public settings to allow only certain users to view chat dialogue. Still further, a chat may include an auto complete dictionary in which, as the user types, words or a dictionary of words containing those letters in the correct order will appear. The user may continue to type the word or may select the correct word as made available to the user by the auto-complete dictionary.

The contextual guide (535) contains a number of tabs (525-1, 525-n) which include all the other content objects explicitly linked to the above content object. These objects may be grouped by tabs which represent the explicit link type or metadata type describing the relationship. This may include explicit linking relationship types such as comments (525-1) or any other type of relationship or content type (525-n). Because the tabs may contain lists of content objects that can not all be displayed at the same time, in one example, they contain navigation buttons (541-3, 541-4) that operate as described above in connection with the next (541-1) and previous (541-2) tabs of the movie tab (508). The tabs (525-1, 525-n) exist to show data related to the spotlighted content object (527). Further, as depicted in FIG. 15A, a particular movie (FIG. 15A, 1501) may be linked to a comment (FIG. 15A, 1502), a person (FIG. 15A, 1504), a group (FIG. 15A, 1505), and a scene (FIG. 15A, 1503). Thus, in one example, this particular movie (FIG. 15A, 1501) corresponds to the spotlighted content object (527) and the comment (FIG. 15A, 1502), person (FIG. 15A, 1504), group (FIG. 15A, 1505), and scene (FIG. 15A, 1503) become the tabs (525-1, 525-n) for the spotlighted content object in the contextual guide (535). The contextual guide (535) can hold any content object in a “spotlight” state, and content objects displayed below as metadata can be moved into the spotlight, which will then show their corresponding metadata below also in the tabs (525-1, 525-n). In one example, a spotlighted content object (527) in the contextual guide (535) is linked to a comment (FIG. 15A, 1502). If, for example, the user desires to know more about this particular comment (FIG. 15A, 1502), the user may select the tab labeled comment (525-1). A description of the comment as well as links to other content may appear in the content display area (527) under the appropriate tab. Additionally, the user may scroll through more information related to this tab (525-1) by using the navigation buttons (541-3, 542-4).

The player panel (534) comprises a video display (528) used to display video images, a progress bar (529) displaying current position in relationship to the overall media, a segment panel (530) for displaying annotations for user interaction which are linked to content objects such as, for example, audio, images, URLs, and explanations, among other annotations. Further, words or phrases appearing in the segment panel (530) may be underlined by different colors designating that a specific word or phrase may be linked to different types of content, such as definitions, audio, images, URL, or explanations. Words and phrases in the segment panel (530) may also be colored according to their relationship with a particular user. For example, a word that a user consistently incorrectly identifies in “test mode” may be colored red.

In one example, the user may toggle between words or phrases linked to definitions, audio, images, URLs, and explanations via a number of checkboxes. In order for the user to gain access to these links the user may simply cock on the word or phrase and the corresponding content object will be displayed in the spotlight area (519) of the contextual guide (535). The user can change which segment appears in the segment panel (530) by clicking the next and previous buttons (536). Users can repeat the current segment, or create a new segment based on the current position of the media by clicking the repeat button (537) at any time it is enabled. This will open a corresponding segment content object in the spotlight area (519) of the contextual guide (535). Before the media is started, or while it is playing, the user can modify the play speed of the media using the play speed control (538). As with other controls in the player panel (534), this control sets properties and calls corresponding methods in the player to alter its behavior.

The user may toggle between full screen and reduced screen via a full screen toggle button (531). The user may also increase or decrease the audio volume via a volume slider bar (532). Additionally, the user may manipulate playback control buttons (533) such as play, pause, stop, fast forward, rewind, next chapter, previous chapter, slow down, repeat, among others, to select any scene from the media and learn a language. In one example, the user may manipulate the controls to adjust the playback speed of an audio or media file using the play speed control (538) described above. Likewise, the segment and audio content object may also contain similar controls to adjust volume, play speed, and whether or not it is synchronized and should start and stop with another content object. The program may provide synchronization of audio files with other audio files, and audio files with segments. For example, the playback speed may be slowed down by the user so the user can better understand a word or phrase. In one example, the pitch of the audio file is not changed when the playback speed is slowed down.

In various examples of FIG. 5, a user may log onto the system and desire to change the language from French to English. In this example, the user cocks on the settings button (504) or perhaps a language dropdown list. Under account settings, the user keeps the native language of Spanish, but changes the target learning language from French to English. The language learning program is now setup for the user to learn English. Individual content objects may also have a language dropdown list to change the language designated for that object. Under the movie tab (508) in the content browser (501), different movie content objects (515-1, 515-2, 515-n) may be displayed in a “reduced” state with their individual titles, pictures, short descriptions of the movies, and movie ratings. The user may click on the navigation buttons (541-1, 541-2) to display more movies. In one example, the user may decide on a movie. In this example, the user clicks on a movie content object (515-1). Information on the selected movie now appears in the contextual guide (535) in a spotlighted state according to the example above. The user is now able to see a longer description (520) of the movie and see other metadata such as comments and other explicitly linked content objects in the tabs below (525-1, 525-n). Users can also add their own explicitly linked metadata such as comments using the add content (524) dropdown box. Other information about the movie may be displayed such as, for example, where the movie was filmed. Further, the add content (524) dropdown box is also used to allow a user to add comments as well as other metadata To play this movie, the user clicks on the media location dropdown list (522) to select where to play the movie from such as a DVD drive, file, or streaming location. Alternatively, if there are no media locations listed, the user can add a location to the media location dropdown (522). The media can auto-play once it is opened, and the user can manipulate playback based on the playback control buttons (533) contained in the player panel (534). The movie is played on the video display (528). The user may increase or decrease the volume via a volume slider bar (532) or with hot keys from the keyboard.

Annotations and subtitles appear in the segment panel (530) in which the user interacts with words, phrases, and other content objects (303) to understand their meaning in the target language. The user may subscribe to a number of phrases, as described below in connection with FIG. 12. The subscription of phrases may be in anticipation for testing later on. As the movie plays, the user may manipulate the playback controls (533) to slow down, repeat, skip ahead, pause, and play the movie to better understand words or phrases contained within the media.

In one example, the movie ends and the user may have a good understanding of the words or phrases contained in the media. The user may select the test mode button (505) to turn the test mode on. The user is tested on a number of the subscribed phrases as described in connection with FIG. 12. The user may also create their own content objects such as audio files that help them practice their pronunciation, and get immediate feedback on whether their recordings are certified or not through the use of voice recognition software or other service that detects whether the audio spoken by the user matches the intended values of the media.

Upon finishing a number of tests and movies, the user may desire to exit the language learning program, and does so using the logout (502) button. As users login and logout of the system, session information is tracked and maintained for later use in metrics. Users can not just see their progress and advancement in the system, but also how many sessions, minutes, and days it took to get them to that level of proficiency. In one example, if the user fails to logout in a timely manner, they will be logged out automatically for security purposes and to maintain an accurate record of system use. Additionally, a number of different combinations and paths a user may take to interact with annotations contained in the GUI and learn a target language may be realized given the language learning program is dynamic in nature.

FIG. 5A is a diagram showing a user interface (500) for the language learning program, according to another example of the principles described herein. In the example of FIG. 5A, the player panel (534) is not just associated with the current segment panel (530) with the corresponding segment content object and media manipulation controls, but also abbreviated segment panels for the previous and next segments in the media (539). Utilizing this example, users can expand the view or change the set of segment panels (530) shown by clicking the next and previous buttons (536). In this way, users can follow along with media in larger chunks than just single segments, but can be tested on entire scenes, lists of segments with common phrases, or short films. In one example, users can create a suite of recordings in-sync with the media segments as they are being played for greater practice imitating real life conversations.

As depicted in FIG. 5A, the segment panel (530) comprises a target segment (562) that a user can read as the user attempts to recite the target segment (562) in, for example, a testing scenario. In one example, as the user recites the target segment (562), a spoken recitation (560) of the user's voice as recorded by the system (100, 150, 200) may be displayed. In this example, the spoken recitation (560) may indicate if, how, and where within the target segment (560) the spoken recitation does not match the target segment (562) and its associated audio data. In one example, different colors may be used to indicate where the user correctly or incorrectly recited portions of the target segment (562). For example, during or after the target segment (562) is recited by the user, portions of the target segment (562) that were not recited correctly may be presented in the color red, and portions of the target segment (562) that were recited correctly may be presented in the color green. In this manner, the user is presented with a visual indication of well he or she recited the target segment (562). In the example of FIG. 5A, the user failed to correctly recite the word “stuck,” within the target segment (562) and, instead, recited the word “suck.” Therefore, the word “suck” may be presented to the user in red. Further, the user recited the word “forever” correctly, and, in this example, the word “forever” may be presented in the spoken recitation (560) in green.

In the example above, the user's ability to say the target segment (562) correctly is being tested. However, in another example, the user's ability to write the target segment (562) correctly may be tested by allowing the user to type into the segment panel (530), for example, the segment the user is listening to. In this example, the target segment (562) may not be displayed to the user in the segment panel, but may be displayed after the user finishes typing what he or she hears. The typed recitation may then be compared to the target segment (562) as described above.

In one example, an animated indicator (568) may be displayed that assists the user to follow along with the target segment (562) as the media player renders the audio and/or video associated with the target segment (562). The animated indicator (568) also assists the user in understanding the timing and rhythm of the target segment (562). Further, as the target segment (562) is being output to the user, an audio waveform visualization (570) and an associated timing indicator (566) may also be presented to the user to assist the user in understanding where within audio track of the target segment (562) the user is currently listening.

A repeat button (564) may also be provided within the segment panel (530) to, when selected by the user, repeat the segment currently displayed as the target segment (562). A volume button (572) may also be provided within the segment panel (530) to, when selected by the user, adjust the volume of the audio track associated with the media output to the user.

FIG. 6 is a flowchart (600) showing how the language learning program user account is instantiated, according to one example of principles described herein. In one example, a user account is created (block 601) in order for the user to access the language learning program and for the language learning program to store user information, such as, for example, the name of the user, language settings, progress of the user, user content, and user settings, among others. User accounts can also be created ahead of time by an administrator. In one example, the user account can be created provisionally by another user in the system inviting a friend or contact to also join. In this example, the invited friend may receive an e-mail or other notification about their provisional account. Additionally, in one example, each user may create a unique user name and password by which the language learning program will identify each user. A user account may be created by the user, an administrator, or in the case of use in a school or company, by a person designated to do so such as a teacher, principal, administrator, or any combination thereof. Having thus created a unique name and password the system may login (block 602) the user to change program settings or add content, among other desired operations.

In keeping with the given example above, a user account (block 601) is created in order to log into (block 602) the language learning program. When a user creates an account, the username and password must be unique for each user. In some cases, the user name is the users email. Further, a user name and password must conform to certain criteria for username and password generation established by the developer. If the user's username and password do not conform to the criteria set forth by the developer, the user must reenter a username and/or password that will conform to the criteria set forth. A user may create the username YodaFor2012, for example. The language learning program will check the database of usernames. If the username YodaFor2012 has not already been taken by another user, the user may use this username as long as it conforms to the criteria set forth by the developer. In keeping with this example, if the username YodaFor2012 has already been taken, the system presents a message to the user that the username has already been taken and prompting the user to select a different user name. The user must choose another username that has not already been taken by another user and conforms to the criteria set forth by the developer, or the user can select an auto-generated name suggested by the system. Various activities may be required to complete the account creation such as, but not limited to, verification of the e-mail address, acceptance of terms and condition for using the language learning system, and selection and payment of subscription.

Components of the language learning program, such as the player and all required files, libraries, and codecs necessary to render various media types, are downloaded (block 603) to a client device (108) such as, for example, a computer system or a smart phone as described above in connection with FIGS. 1A and 1B. Downloading the program instructs the client device (108), and gives functionality for the complete language learning program. Not all modes of the language learning program require downloading and installation of additional files, but may be needed for advanced features or specific media types. The program components may be downloaded by, for example, but not limited to, using the World Wide Web, compact disk, or any media capable of storing such a program such as an external hard-drive or USB drive. Depending on the type of media files that a movie may be stored on, downloading additional codex, libraries, or files (block 603) may be performed to allow third party media to be rendered. These media files, as noted above, may include, but are not limited to, DVD files, .avi, .mp4, .flv, .wmv, and streaming files, such as, RTMP, and RTSP. Thus, the language learning program may play any type of media that the user provides.

In one example of FIG. 6, the user may download (block 603) the language learning program using a network such as, the World Wide Web. In one example, the user may desire to provide a DVD as media. Provided the user has installed the correct codex, libraries, or files (block 603) to play such a media, the content of the DVD will play on the language learning program. The user may use media files such as, .avi, .mp4, .flv, .wmv, stored on their computer device and desires to use this type of media on the language learning program. The user may have to download a number of codex, libraries, or files required to play such media. In one example, the user does not have the correct codex, library or the to play .avi files. In this example, the user may, in order to play an .avi file, download (block 603) the correct codex, libraries, or files associated with .avi files. Once the user has downloaded the correct codex, libraries or files (block 603) the user may play .avi files on the computer device.

FIG. 7 is a diagram showing a method for extraction of segment content objects from media subtitles, according to one example of principles described herein. According to certain illustrative principles, the media (701) interacts with a decoder (702). The decoder, (702) being a software component, is used to decode audio and video streams. The decoder (702) decodes the media into a number of streams which can be redirected to a number of filters for additional processing; including an audio filter (703), a sub-picture filter (704), and a video filter (705), among other filters. These filters (703, 704, 705) are used to process and manipulate a data stream. Further, these filters (703, 704, 705) may be used in any combination such as in series to create a filter chain in which one filter receives the output of the previous filter.

In order to extract segments from media subtitles, a sub-picture filter (704) is used on the sub-picture stream from the decoder (702). From the sub-picture filter (704), a subtitle filter (706) may filter a desired portion of the sub-picture filter (704). Once the subtitles are filtered out, the subtitles are in the form of an image. Image processing may be helpful to improve optical character recognition (OCR) (707), used to transform the picture subtitle image into a text based format. Image processing may include changing the colors, font, or beveled status of the image, as well as detecting the precise position in the media the image appeared, disappeared, or changed. Segment information containing the OCR'ed text, start time, and end time is stored in the player's database cache (FIG. 1, 137), and can be uploaded to the application server (138) as complete segments or as a list of words and phrases for each segment. It is unnecessary to store the entire segment on the application server (138) as they can easily be regenerated each time the media is rendered. However, the list of words and phrases used in each segment can be stored in the application server database (140) to enable search capabilities. Segments (709) and other metadata types of content objects (711) can be stored in the database cache (FIG. 1, 137) as well as additional information such as the segment track or subtitle file that may have been used. The database cache (FIG. 1, 137) may also contain other data cached on the local client for performance considerations. Thus, segments may be extracted from the media subtitles and stored on a local client device (108) as well as on the application server database (140). Consequently, media subtitles may be extracted once and stored or each time the media is played if desired. If the user plays a segment that has already been rendered, the media player may use the database cache (FIG. 1, 137) to provide subtitle information.

FIG. 8 is a diagram showing a method (800) for extraction of closed captioning, according to one example of principles described herein. In one example, the media (801) is decoded using a decoder (802). The decoder (802), being a software component, is used to decode audio and video segments. The decoder (802) decodes the media into a number of segments using a number of filters, including the audio filter (803), the closed captioning filter (804), and the video filter (805), among others. The dosed captioning filter (804) is a text-based filter. Thus, there is no need to OCR the closed captioning, making the dosed captioning extraction method easier. Closed captioning (810) and metadata such as content objects (811) are stored for each segment (809) on a local database cache (FIG. 1, 137) as described above. Thus, segments may be extracted from the media dosed captions and stored on a local client device (108) as well as on the application server database (140). Consequently, media closed captioning may be extracted once and stored, or each time the media is played if desired. If the user plays a segment that has already been rendered, the media player may use the database cache (137) to provide closed captioning information. In addition to extracting segments from media subtitle and closed captioning data, the program may also extract other content objects and annotations from various media file formats and metadata file formats such as, but not limited to MPEG-4 files, .srt files, and others. This data can be sent directly to either the local database cache (137) or the application server database (140).

In one example, the player's local database cache (137) contains more than just information on extracted segments from media and related files. It also contains information on audio files that were created locally, including visualizations of those files displayed to the user. Some system data will only be generated by the player such as audio files generated by recording audio on the client device (108) through the audio in component (FIG. 1, 135). There is a synchronization mechanism between the player's local database cache (FIG. 1, 137) and the application servers database (FIG. 1, 140) that uploads and downloads data as necessary. The application server database (140) is the master and winner in any conflicts that may occur.

FIG. 9 is a diagram showing how user created content objects can be certified as having been created correctly, which in turn increases the metrics and score a particular user will have for words and phrases related to that content object. As discussed in FIG. 3, a user at some point will create new objects as metadata (block 304). In one embodiment, a user will create an audio content object as metadata (and hence an explicit link) to an existing segment or other audio object. Creating an audio content object gives the user an opportunity to test their ability to speak words and phrases. And if the user does a good job and their work is certified, then that audio content object can be consumed by others, giving the author a chance to receive micropayments based on consumption and ratings. For some content objects such as audio recordings there are corresponding files and data that are initially stored in the local database cache (137) but that need to be uploaded to the application server database (140). This uploading of the related audio files (block 901) can take place as part of a regular client/server synchronization process or immediately when a new content object is created or edited.

Once a new content object such as an audio file arrives into the application server database (140) it can be evaluated to see if the author created it correctly and certified so that other users can depend on it for their own language education. In one example, the content object is certified by an auto-evaluation process (block 902) built into the system. For something like an audio object, the auto-evaluation can be, but is not limited to, use of voice recognition software or service that detects whether the audio spoken by the user and captured by the system matches the intended value. For example, if a user plays a movie segment that says “I'll be back” and they create an audio content object tied to that segment, and perhaps records it in-synch with the segment, then that audio file should return “I'll be back” as plain text from the voice recognition engine. If so, the audio content object is certified. In either case, the user is given immediate feedback on to how well they mimicked the movie segment. The audio content object created by the user's recording of his or her rendition of “I'll be back” is then set to the appropriate certified or uncertified state (block 904).

In FIG. 9, whether or not a content object passes the auto-evaluation logic (block 902), it is helpful to have a user's work evaluated by their peers. Other users in the system can enter a “test mode” on new, uncertified content, and be tested on their own comprehension (block 903). If, for example, someone can correctly identify the text of a recorded audio, then it was most likely spoken correctly. If enough users get the correct answer, and a certain number of those users are certified to speak that language, then the content object can be certified whether or not it passed the auto-evaluation step (block 902). The content object is then set to the appropriate certified or uncertified state (block 904).

In FIG. 9, when a content object has been set to a certified or uncertified state (block 904), there are implicitly linked words/phrases content objects that can now have their states updated (block 905). For example, if a user correctly records the audio “I don't know you,” the words/phrases within that audio file each have the implicitly linked content objects “I,” “don't,” “know,” and “you.” and since the user must have said each of those correctly, the user can be set to the state of “can-speak” pertaining to those words/phrases. It may be required to say individual words/phrases multiple times before they are marked in the “can-speak” state. FIG. 18 explains this process in more detail.

FIG. 10 is diagram showing a method for the user to create new or modify existing segments, according to one example of the principles described herein. In one example, as the media (1001) plays, the user may open a segment content object or see a segment annotation appear within the user interface (1002). Alternatively, the user may mark or repeat a section of a movie to create a new segment content object (1003). The user may then edit (block 1004) segment data such as text, or start time and end time of the segment. All segments (1005), whether user-defined or derived from files, subtitles, or closed captioning are stored first in the local database cache (FIG. 1, 137) before being synchronized with the application server database (FIG. 1, 140). If changes to a particular segment (1005) are deemed authoritative, the synchronization can go the opposite way from the application server database (140) to the local database cache (137) of other users in the system. It should be noted that segments can also be grouped in to scenes and larger aggregates, and there are different types of segment data that span very short utterances and longer scenes and phrases.

FIG. 11 is a flowchart showing a method for creation of content objects, according to one example described herein. According to one example, the method for the creation of a content object comprises a user logging (block 1101) into the language learning system. Further, a user adds (block 1102) content or posts rating for other users. Any metadata content such as a comment added to the system may be classified as new content objects with an explicit relationship to the aforementioned content object. Content objects may include, but are not limited to, audio files, persons, scenes, movies, comments, groups, chat, ratings, or lessons, among others. Further, upon adding explicitly linked content objects, (block 1102), the added content become content objects (block 1103) available for consumption by other users in the system. Whether an object was created with an explicit link, there is almost always an implicit link based on the name of each content object as described in connection with FIG. 15A and FIG. 153. Ratings themselves are not classified as content objects, but the number or average value of ratings do affect sort order and payments to content object authors.

In various examples of FIG. 11, the user logs into (block 1101) the system. As the user accesses media or chooses words from a list, a science fiction movie about alien invasions may be accessed. In this example, the user may hear the phrase “Two hours after the first contact, an unidentified enemy has reached our coastlines in a swift and militaristic attack. Right now one thing is clear: The world is at war,” The user may add (block 1102) the comment, “If you want to see a good movie where the world is at war see the new version of ‘War of the Worlds.’” The comment content object (block 1102) becomes implicitly linked to the phrase “The world is at war” as described in connection with FIG. 153. Additionally, the comment (block 1102) may also be explicitly linked, as described in connection with FIG. 15A, in which the phrase may be explicitly linked to another movie, such as, “War of the Worlds,” a

Additionally, versioning may be applied to a number of content objects. Versioning includes a method in which a user may own a number of content objects. However, not all content objects need to be owned. According to certain illustrative examples, if a user creates a content object, the user owns that content object, can edit that content object, can delete that content object, or can modify that content object. In one example, a user, Eric, may create a content object in the form of a comment. Eric may write the comment, “The director originally wanted to have a dog fight between the Americans and the Russians using two SR-71 blackbirds in this scene.” Eric now owns this content object. He may modify this content object at any time to suit his needs. Another user, Wes, may read Eric's comment about the SR-71 blackbirds. Wes may realize the SR-71 blackbird is an American plane and the Russians would not be flying an SR-71 blackbird also. According to the principles and methods of versioning, Wes cannot modify Eric's comment about the SR-71 Blackbird. However, Wes may create his own content object explaining that the Russians would not have access to an SR-71 blackbird. At some point Wes' version may bubble up to become the default version of that content object based on a number of factors, including, but not limited to, the authority and status of the Wes and Eric. However, but only the default version is implicitly or explicitly linked to other content objects.

Further, in this manner, Wes may indicate that Eric's comment could not be valid in an effort to promote his own version as the default. When content objects have multiple versions, users can choose to see them, rate them, and, hence, influence which one becomes the default version. Thus, each user may only modify his or her content objects and not other users' content objects directly.

FIG. 12 is a flowchart showing a method (1200) for testing a user on phrases, according to one example described herein. As the media is playing, a user may desire to understand a certain word or phrase. The user may click on the word or phrase contained in the segment bar (FIG. 5, 530), for example. A translation or definition of the word or phrase appears to help the user understand the content. Further, if the user desires to certify mastery of a word or phrase, the user may subscribe to the word or phrase (block 1201). A user may subscribe to segments directly, lists of words and phrases, or individual words and phrases. Additionally, if the user desires not to subscribe to a word or phrase, the user may decline to subscribe or unsubscribe to any content object. As the media plays, the user may subscribe to a number of words or phrases, segments, lists, or other content objects (block 1201).

When the media segment has ended or when the user decides, the user may select to enter a test mode or may be required by the system to enter a test mode where the user is tested randomly on subscribed content objects or phrases (block 1202). In various examples, the form of a test may include, but is not limited to, listening to a segment or audio and typing the matching words or phrases, alternatively selecting them from a list of options, matching audio with words or phrases from a predefined list, or listening to an audio track and recording the user's voice for playback comparison to the original audio file, among other forms of testing. Additionally, the user's recorded voice may be rated by other users. Thus, the user may learn any word or phrase desired, and receives instant feedback from an auto-evaluation engine as well as comments from other users to determine their individual progress in learning a language.

In one example of FIG. 12, the user may decide to watch a spy movie. In this example, the user is of Latin origin, and the user's native language is Spanish. In keeping with this example, as the movie plays, the phrase “secret agent” is repeated several times throughout the movie. If the user does not know what the phrase “secret agent” signifies, the user may click on the phrase “secret agent,” upon which the word “secret agent” is defined in the native language of the user; in this example, Spanish, as “agente secreto.” Thus, the user is now able to understand the phrase “secret agent.” Further, the user may decide to subscribe (block 1201) to the phrase “secret agent” to be tested on it at a later time. Additionally, the phrase “secret agent” may be linked, as described in connection with FIG. 15A and FIG. 15B, to other media, URL's, audio files, images, comments, and actors, among others, to help the user understand the phrase “secret agent.” As noted above, the user may subscribe to a number of words or phrases, phrase lists, or individual segments (block 1201).

Keeping with the example given above, the user enters the test mode (block 1202) in which random segments containing the phrase “secret agent” appear (block 1203) and are played in the media player. In one example, the random segments containing the phrase “secret agent” are presented without subtitles or other indicators on what is being said. The user is left to input data or select from a list of options the right answer of what is being said (block 1204). In one example, the user may play an audio file in which the phrase “secret agent” is heard. In order to identify whether or not the user has mastered the phrase “secret agent,” the user may type the phrase “secret agent” into a text field box. If the user correctly types “secret agent” the user receives feedback that the phrase was correct. If the phrase is not typed correctly, the user receives feedback that the phrase was incorrect and is prompted to try again. Further, after a number of attempts, the phrase may be displayed and the user may subscribe to the phrase “secret agent” again, and be tested on it at a later time.

In another example, the user may desire to match the audio file with a list of possible choices. The user hears the phrase “secret agent” from the audio file. The user may choose from a set of potentially correct answers. For example, the list may include a number of possible answers, such as, “secret angle,” “separate angel,” “secretary agency,” and “secret agent.” As noted above, if the user correctly selects “secret agent” the user receives feedback that the word was correct. If the phrase is not selected correctly, the user receives feedback that the phrase was incorrect and is prompted to try again. Further, after a number of attempts, the phrase may be displayed, and the user may subscribe to the phrase “secret agent” again and be tested on it at a later time.

Following the above example, if a user correctly identifies the audio being played and, hence, passes the test, the state of that content object can be updated to “passed”. If the user got the right answer, but with help from a list of options, the state of that content object can be updated to “passed from list.” If the user got the right answer, from a list after previous wrong answers the state of the content object could be updated to “passed by guessing.” If the user was not able to get the right answer, the state could be updated to “failed.” For content objects that were passed successfully, there are number of implicitly linked content objects that now need their respective states updated (block 1205). For example, if a user correctly identifies the text for a segment playing where an actor says “What a friend,” then the implicitly linked content objects “what,” “a,” and “friend” can be updated to the state of “can-recognize” because the user necessarily recognized each individual word to recognize the segment as a whole. In one example, it may be that a single word or phrase needs to be recognized multiple times before its corresponding word/phrase content objects is so updated.

FIG. 18 is a diagram showing a method for determining whether a user can speak, recognize, or both speak and recognize a particular word or phrase that comes from a one or more segment content objects, according to one example of the principles described herein. Therefore, this method will be described ion more detail below in connection with FIG. 18.

Turning again to the examples of FIG. 12, the user may desire to record their own voice and compare it with that of an original audio file contained within a segment. In this example, the user may see a visual rendering of the audio file, “secret agent” being displayed. The user may record their voice and compare it visually and audibly against the original audio file. The user may re-record their voice as many times as desired. Once the recording is submitted, any user may comment or give feedback on the recording. Other certified and non-certified users may rate the recording and give feedback to determine if the user's recording may become certified or not. In one example, a certified user is someone who has achieved a certain proficiency in the language being tested, such as a native speaker. Further, the language learning program may incorporate third party voice recognition software which will compare the user's recorded voice with that of the actual audio file. The voice recognition approach is the auto-evaluation (block 902) branch in FIG. 9 and the peer-reviewed branch where the user enters a “test mode” on the submitted content object (903). In the case that the user's voice and the actual audio the match, feedback will be given to the user signifying the user pronounced the word or phrase correctly. In the case where the user's recorded voice does not match the actual audio file, feedback will be given to the user signifying the user pronounced the word or phrase incorrectly. Additionally, a voice recording may be delivered by a voice over internet protocol (VoIP) in which the delivery of voice communications and multimedia sessions may be received over a network. The network may be, for example, the World Wide Web, the Internet, intranet, or internet.

In one example, a certified user, certified administrator, or a process and set of rules for a computer to follow may be used to rate and certify other user's voice recording. A user becomes certified for a particular phrase or segment once they themselves have passed a proficiency test corresponding to that phrase or segment. For example, John may have received a proficiency score indicating he can speak and recognize the phrase “go ahead, make my day.” Thus, John is certified to rate other users on the phrase “go ahead, make my day.” Two other students, George and Jerry, may have subscribed to the phrase “go ahead, make my day,” and may have recorded their voices saying this phrase. John, who is certified, listens to George's and Jerry's voice recordings. In this example, John may determine that he can understand Jerry's voice recording, but cannot understand George's voice recording. Consequently, Jerry receives a positive rating and the distinct words or phrases in that text are set to a “can-speak” state.

However, George receives a negative rating. Thus, Jerry is now certified to certify other users saying the phrase “go ahead, make my day,” and George does not receive a certification to certify other users' saying “go ahead, make my day.” Details for proficiency scores are set forth in connection with FIG. 17 and FIG. 18. In this manner, the progress of a user may be measured by the user's ability to recognize a content object, create a number of content objects correctly, create relationships between a number of a content objects, have others understand audio recorded, or successfully have the content object measured by auto-evaluation such as voice recognition.

FIG. 13 is a flowchart showing a method for receiving micropayments, according to one example described herein. The micropayment system and method described herein may be implemented using hardware or a combination of hardware and software. The micropayment process may begin when a user logs into (block 1301) the system. Every time a user logs in, the language learning program may identify the user. After the user logs in (block 1301), the user may post ratings for other users or add content in the program (block 1302). The content may include, but is not limited to, ratings for movies (FIG. 5, 523), rating another user's voice recording, and adding comments to media segments. The user may add as much content as desired. After a number of ratings have been posted or content added within a period of time, the user may be eligible to receive a micropayment (block 1303). In one example, each micropayment is based on the number, quantity or a combination of the number and quality of added content such as the above-described ratings and content the user uploads to the system. In one example, a micropayment may take the form of, but is not limited to, a payment being made via a PAYPAL online payment account service offered by PayPal. Inc., or any other electronic money transfer system. In another example, a micropayment may take the form of a lower price for subscription to the disclosed language learning service. In this example, a temporal subscription payment such as, for example, a monthly subscription may be credited or a future monthly subscription may be discounted. Thus, by allowing the user to add content and ratings to the system the user will receive incentives via these micropayments to add complexity and depth to the language learning program.

In one example of FIG. 13 a user, after logging in (block 1301), may decide to watch an action movie. While watching the action movie, the user may notice a certain scene takes place in the Bahamas, but the actual scene was filmed on a studio set. The user may add a comment (block 1302) to the segment indicating that the scene was filmed on a studio set. Later on, the user may realize that a certain actor is missing from the cast list. The user may add the actor's name (block 1302) to the cast list. Additionally, as the movie plays the user may add content including comments (block 1302) about scenes, actors, and directors. Further, after the movie has finished, the user may rate the movie (block 1302) and also rate recordings of other users speaking certain parts of the movie. In these examples, the user adds content to the media, allowing other users to see and comment on the content. After a period of time, the user may have added a number of content elements and ratings to the media. In exchange, the user receives a micropayment (block 1303) or a number of micropayments associated with these additions of content.

FIGS. 14A and 14B are images of the content browser (1400, 1422), in which the list of content and corresponding media is expanded or collapsed respectively, according to one example described herein. In one example, media selections may be available to the user in which a number of selections are categorized in a category list (1401) and laid out on a two dimensional grid (1402) as shown in FIG. 14A. In one example, the media may be categorized in the category list (1401) as types of media such as, DVD, media files, or streaming files, among others. In another example, media may be categorized by release date, newly added media, genre, recently viewed, or most popular, among other categories. Often it is the case, that the content browser and corresponding media (1400) are categorized by several categories as illustrated herein.

The two dimensional grid or array of titles (1402) as shown comprises vertical columns and horizontal rows where titles (1407) as well as other helpful information about the media may be displayed to help the user select the desired media. Additionally, navigation buttons (1403) are incorporated in order to help the user navigate the information that is not shown on the screen. The navigation buttons (1403) help the user to find more titles (1407) of media or navigate through the category list (1401). As illustrated in FIG. 14B the content browser (1422) may be collapsed reducing the array of titles (1402) into a single row of titles (1425). The collapsed content browser (1422) condenses the media information into a smaller screen. The navigation buttons (1423) function as described above.

In some cases, as illustrated in the example of FIG. 14A, the user may scroll, using the navigation buttons (1403), through the category list (1401), displaying a number of categories at a single time. In expanded view the user may see a number of media tides (1407) arranged in a two dimensional grid (1402) or array of tides (1407). If the user desires to see more media files, the user may click on the navigation buttons (1403) to see additional category lists (1401) or media titles (1407). Additionally, a number of media category lists (1401) and a number of media tides (1407) may be contained within the expanded content browser. The user may select one media file or a number of media files. If a number of media files are selected, the media files are queued in the order they were selected. Additionally, the user may use the maximize button (1408) to see a number of categories related to the media type and a number of media titles (1407) may be contained within the content browser. Once a number of media files have been selected, the media player access the media and plays the media as described in connection with FIG. 4.

In other cases, as illustrated in the example of FIG. 14B, the user may desire to have a collapsed view of the content browser and corresponding media. As noted above, the user scrolls, using the navigation buttons (1423), through the category (1421) layout, displaying one category at a single time. In collapsed view, the user is presented a number of media tides (1427) arranged in a single row (1425). If the user desires to see more media files, the user may click on the navigation buttons (1423) to step through the category list (1421) or scroll through media tides (1427) in the collapsed grid (1422). Additionally, the user may use the maximize button (1426) to see a number of categories related to the media type. Further, a number of media tides (1427) may be contained within the collapsed content browser of FIG. 14B. The user may select one media file or a number of media files. In one example, if a number of media files are selected, the media files are queued in the order they were selected. Once a number of media files have been selected, the media player accesses the media and plays the media as described in connection with FIG. 4.

FIGS. 15A and 15B are diagrams of explicit and implicit linking, respectively, of content objects, according to one example described herein. As noted above, content objects may be linked by either explicit or implicit linking. Each time a content object is created, depending on the type of object content, the content object may be linked by methods of explicit and/or implicit linking as described below.

FIG. 15A demonstrates the use of explicit linking. As shown in FIG. 15A, different types of content objects may be linked explicitly, such as, but not limited to; movies, comments, persons, groups, scenes, lessons, and audio files. Each type of content object may be explicitly linked to related content objects, and the user may transverse these explicitly related content objects to, for example, understand words, phrases, ideas, or expressions used in the context of a content object being reviewed by the user. In various examples, and as illustrated in FIG. 15A, a movie (1501) may be accessed. As the movie (1501) plays, a comment (1502) may have been created that relates to the movie (1501). The user may desire to understand or learn more about the comment (1502). For example, the comment (1502) may be, for example, “The phrase, ‘Houston, we have a problem’ is repeated in several movies related to space.” The user may click on the comment (1502) which may be displayed in the segment panel (FIG. 5, 530). This comment (1502) may be related or linked to other content objects such as, a lesson (1506) about space missions where the astronaut said this famous phrase. In keeping with the example above, the comment (1502) may also be explicitly linked to an audio file (1508). This audio file (1508) may include real space mission recordings in which astronauts say, “Houston, we have a problem” or another user's recorded voice saying “Houston, we have a problem.” Further, in keeping with the example above, the comment (1502) may also be explicitly linked to a scene (1507). This scene (1507) may comprise of a location in which the movie (1501) was filmed or a segment within the movie (1501) where the comment (1502) was quoted. The scene content object (1507) may contain more information including details about the scene in which the user may learn more about the scene. Additionally, the lesson (1506), audio file (1508), and scene (1507) may be explicitly linked to other content objects. These content objects, as noted above, may be created by a user, developer, or administrator. Further, in one example, the explicit linkage between content objects may be made autonomously by the present system or may be performed via a user, developer, or administrator indicating the explicit linkage between two or more content objects.

In keeping with the given example above and as illustrated in FIG. 15A, the movie (1501) may be explicitly linked to a person (1504) in which this person (1504) may be explicitly linked to, for example, a group (1509), a lesson (1510), and a comment (1511). Further, this movie (1501) may also be explicitly linked to a group (1505) in which the group (1505) is explicitly linked to an audio file (1512), person (1513) or scene (1514). Additionally, this movie (1501), may also be explicitly linked to, for example, a scene (1503) in which the scene (1503) is explicitly linked to an audio file (1515) or a lesson (1516). As noted above, any content object may be explicitly linked to a number of other content objects in which those content objects may be related to a number of other content objects and so on. In one example, the user may transverse a number of content objects (1501-1516) that are explicitly linked together. As the user transverses a number of content objects, the user may subscribe to these words or phrases in order to learn a language.

Turning now to the example of FIG. 15B, words or phrases (1517, 1522, 1526) may also be implicitly linked to a number of content objects. These content objects include, but are not limited to, audio files, persons, scenes, movies, comments, groups, chats, or lessons. Additionally, every content object may have a name in which each implicit link is made according to a name. For example, in a phrase (1517) such as, for example, “You can't win, Darth. Strike me down, and I will become more powerful than you could possibly imagine,” a number of words or the whole phrase may be implicitly linked to other content objects such as, an audio file (1519), a person (1520), or a scene (1521). The user may desire to know who played Darth Vader. Since the word “Darth” is a content object within the example phrase (1517) above, the user may select the word “Darth” located in the segment panel (FIG. 5, 530). Related content objects about Darth Vader may appear. The user may learn additional information such as the fact that the Darth Vader on screen character was played by one person, but the voice for Darth Vader was played by another actor.

Additionally, this phrase (1517) may be linked to an audio file (1519). This audio file (1519) may comprise other times or instances when this phrase was used in the movie or another movie, or may comprise of other users' recorded voices saying the phrase. In addition, the phrase (1517) may also be implicitly linked to a scene (1521) in which details about the scene may be given such as a location, time spent on the scene (1521), or a number of other details about the scene (1521).

In one example, a number of words or phrases (1517, 1522, 1526) may appear in a number of scenes within a movie. Each word or phrase (1517, 1522, 1526) may be implicitly linked to a number of content objects (1519-1521, 1523-1525, 1527-1529). As noted above, these content objects (1519-1521, 1523-1525, 1527-1529) may include, but are not limited to, audio files, persons, scenes, movies, comments, groups, chat or lessons in which the user may transverse to learn a language.

Further, in another example, the user may traverse a number of content objects (1501-1516) that are explicitly linked together, as well as any content objects (1519-1521, 1523-1525, 1527-1529) that are implicitly linked to those explicitly linked content objects (1501-1516). Thus, in this example, explicitly and implicitly linked content objects (1501-1516, 1519-1521, 1523-1525, 1527-1529) may be traversed by the user in order to better understand the content within the various types and instances of the content objects (1501-1516, 1519-1521, 1523-1525, 1527-1529). This ability to traverse a number of explicitly linked content objects (1501-1516) and a number of implicitly linked content objects (1519-1521, 1523-1525, 1527-1529) allows a user of the present system to learn the target language so that it is interesting for the user. This keeps the user captivated by the present language learning system. Further, the present systems and methods allow a user to learn topics in a target language that will assist in or relate to a user's daily activities such as, for example, the user's profession. Still further, the present systems and methods allow a user to learn the target language at his or her own pace.

FIG. 16 is a diagram showing a recursive tree reporting hierarchy for permission, management, and reporting purposes, according to one example of the principles described herein. According to certain illustrative examples, FIG. 16 supports a method for organizing groups and subgroups based on two main components: a user and a group. A group may consist of users, groups, or users and groups. Rights management utilizes this same structure; for example, if a group has the right to view or edit a specific content object, every member of the group inherits those same rights. Likewise, with reporting, members of a group can see numbers for each member of their peers, but not numbers of a peer group. In one example of a school setting, a user teacher (1601) may oversee three groups; namely, group A (1602), group B (1603), and group C (1604) in the example of FIG. 16. In this example, each group (1602, 1603, 1604) may have two students and one subgroup. Group A (1602) may have student A (1605), student B (1606), and subgroup B (1603). Group B (1603) may have student D (1608), student E (1609), and subgroup D (1610). Group C (1604) may have student G (1611), student H (1612), and subgroup E (1613). In one example, the teacher (1601) may see the progress of any group or any student, but subgroups cannot see the progress of anything above their immediate level.

FIG. 17 is a diagram showing a user content object (1700) with metrics, according to one example described herein. According to certain illustrative concepts, the user tab (1700) includes a user name (1702) with a corresponding overall user proficiency score (1703). The overall user proficiency score (1703) is determined by a number of criteria; including, “can-speak” proficiency score (1704), “can-recognize” proficiency score (1705), and an-speak-and-recognize” proficiency score (1706), among others. The scoring of these criteria is described in connection with FIG. 18. A process and set of rules for a computer to follow may be used to combine each proficiency score (1704-1706) to give the user an overall user proficiency score (1703). The higher each score (1703-1706), the more proficient an individual is at speaking a language. User content object may also contain a picture, status, and other information.

In one example, a user named, for example, Juan (1702), has a “can-speak” proficiency score (1704) of 50, meaning Juan (1702) can speak 50 words or phrases. Juan (1702) may also have a “can-recognize” proficiency score (1705) of 35, meaning Juan (1702) can recognize 35 words or phrases. Juan may also have a “can-speak-and-recognize” proficiency score (1706) of 7, meaning of the 50 words he can speak, and the 35 words he can recognize Juan (1702) can speak and recognize 7 words or phrases because 7 words are in both the “can-speak” and “can-recognize” categories. According to certain illustrative principles a process and set of rules for a computer to follow may be used to combine each proficiency score (1704-1706) together to give Juan (1702) an overall user proficiency score (1703) of, for example, 31. A teacher may compare Juan's overall proficiency score (1703) with that of other students. Any number of rules may be used to calculate the “can-speak” proficiency score (1704), “can-recognize” proficiency score (1705), and “can-speak-and-recognize” proficiency score (1706), and the overall user proficiency score (1703).

FIG. 18 is a diagram showing a method for determining whether a user can speak, recognize, or both speak and recognize a particular word or phrase that comes from a one or more segment content objects, according to one example of the principles described herein. FIG. 18 describes a method for rating a user's proficiency in both speaking and recognition. In the example of FIG. 18, a number of segments have been subscribed to (1801, 1803, 1805, 1807), and, after entering “test mode,” the user achieved the corresponding states for each test of “passed” (1802), “passed from list” (1804), “passed by guessing” (1806), and “failed” (1808). For each of the segments listed, the user also created corresponding audio objects (1809, 1811, 1813, 1815) recording themselves saying the same text from the segments. Because each audio content object was created as metadata to the segment objects, there is an explicit link between each segment-audio pair (1849, 1851, 1853, 1855). Likewise, each audio object was evaluated as to whether it was done correctly, and, hence, certified (1814, 1816) or left uncertified (1810, 1812).

Word/phrase content objects are implicitly linked, and, therefore, easily identified for each word or phrase in both the segments and audio files. In this example, only words are used (such as “I”, “love,” and “you”). However, in another example, “I love you” may be retained as a single phrase with its own word/phrase content object. The individual words/phrase content objects in the example of FIG. 18 (1817, 1819, 1821, 1823, 1825, 1827, 1829, 1831, 1833, 1835) are updated with their own status after one or more corresponding content objects have either been certified or had a successful test with “passed” status. The reason the word/phrase “love” (1833) was marked as “can-speak” (1834) is because the word “love” was used in a certified audio content object (1813). Likewise, the word/phrase “what” (1835) was marked as “can-speak” (1836) because the audio “what a friend” (1815) was also certified.

Following the same example, the word/phrase “don't” is marked as “can-recognize” because the segment with the text “I don't know you” was successfully recognized in test mode. The word “1” (1817) is marked as can-recognize-and-speak” because the word “I” was successfully recognized in a content object (1801) and successfully recorded in a certified audio object (1813). Because the language learning system keeps track of each user's relationship to each content object whether it be a word/phrase, segment, audio, or other types of content objects, the system can prepare and present reports with metrics on the progress of users over time. Users can get reporting for themselves and their groups on which words and phrases they have struggled with, which media items used tended to give the best results, and many other types of language learning statistics.

Aspects of the present systems and methods are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (106) of the client device (108), the processor (221) of the administrator device, (201), or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is non-transitory.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which comprises a number of executable instructions for implementing the specific logical function(s). It should also be noted that, in some alternative implementations, the functions noted in the block diagrams may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicates otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

The specification and figures describe a method, system, and computer program product for providing a language learning environment. The method, system and computer program product comprise comprises a processor, and a memory communicatively coupled to the processor, in which the memory comprises of metadata for the media, and in which the processor executes computer program instructions to, access media, and identify a number of content objects associated within the media instance. This language learning environment may have a number of advantages, including: (1) allowing a language learner to learn a non-native language in a captivating manner; (2) making the learning of a non-native language captivating and interesting to a language learner; and (3) increasing the ability of the language learner to understand spoken and written language and pronunciation.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of providing a language learning environment, comprising:
accessing media content; and
identifying a number of content objects associated within the media instance.

2. The method of claim 1, further comprising receiving a number of identified content objects.

3. The method of claim 1, further comprising:
manipulating the playback of the media in response to a user's manipulation of a number of playback controls;
receiving user selections indicating interaction with annotations associated with the media;
receiving user selection of a number of annotations associated with the media;
subscribing to a number of annotations associated with the media for testing upon a user's subscription selection; and
performing a number of tests on the user using a number of subscribed annotations associated with the media.

4. The method of claim 3, in which receiving user selections indicating interaction with annotations associated with the media further comprises extracting subtitles in the media for user interaction.

5. The method of claim 3, in which receiving user selections indicating interaction with annotations associated with the media further comprises extracting dosed captioning in the media for user interaction.

6. The method of claim 3, in which receiving user selections indicating interaction with annotations associated with the media further comprises extracting .SRT files in the media for user interaction.

7. The method of claim 3, in which receiving user selections indicating interaction with annotations associated with the media further comprises defining subtitles in the media for user interaction.

8. The method of claim 3, in which receiving user selections indicating interaction with annotations associated with the media further comprises:
receiving a user's addition of content or ratings, the added content and ratings becoming content objects.

9. The method of claim 8, in which a receiving a user's addition of content or ratings further comprises:
distributing micropayments to the user after a period of time based on a number of rating and content objects that have been added by the user.

10. The method of claim 8, in which receiving a user's addition of content or ratings, the added content and ratings becoming content objects further comprises:
linking the content objects explicitly with existing content objects.

11. The method of claim 8, in which receiving a user's addition of content or ratings, the added content and ratings becoming content objects further comprises:
linking a number of phrases implicitly with the added content objects.

12. The method of claim 3, in which subscribing to a number of annotations associated with the media for testing upon a user's subscription selection further comprises:
subscribing to a number of words, phrases, or phraselists; and
testing on subscribed words or phrases in a random order.

13. The method of claim 12, in which testing on subscribed words or phrases in a random order further comprises:
receiving a user's selection of a phrase definition from a number possible choices for a number of subscribed words.

14. The method of claim 12, in which testing on subscribed words or phrases in a random order further comprises:
receiving a user's typing of a phrase for a number of subscribed words.

15. The method of claim 12, in which testing on subscribed words or phrases in a random order further comprises:
recording a user's voice saying a word for a number of subscribed words,
in which the user may be rated to affect a proficiency score of the user.

16. The method of claim 15, in which the ratings of the recording of the user's voice are obtained by receiving ratings input by a number of other users.

17. An apparatus for providing a language learning environment, comprising:
a processor; and
a memory communicatively coupled to the processor;
in which the memory comprises of metadata for the media, and in which the processor executes computer program instructions to;
access media; and
identify a number of content objects associated within the media instance.

18. The apparatus of claim 17, in which the processor further receives a number of identified content objects.

19. The apparatus of claim 17, in which the processor executes computer program instructions to:
manipulate the playback of the media in response to a user's manipulation of a number of playback controls;
receive user selections indicating interaction with annotations associated with the media;
receive user selection of a number of annotations associated with the media;
subscribe to a number of annotations associated with the media for testing upon a user's subscription selection; and
perform a number of tests direct at a user using a number of subscribed annotations associated with the media.

20. The apparatus of claim 17, in which the processor accesses media using a media player.

21. The apparatus of claim 17, in which the processor further executes computer program instructions to subscribe to a number of annotations based on a number of user requests.

22. The apparatus of claim 17, in which the processor further executes computer program instructions to test the user on a number of annotations to which the user is subscribed.

23. A computer program product for providing a language learning environment comprising:
a computer readable storage medium comprising computer usable program code embodied therewith, the computer usable program code comprising:
computer usable program code to, when executed by a processor, access media; and
computer usable program code to, when executed by the processor, identify a number of content objects associated within a media instance.

24. The computer program product of claim 23, further comprising:
computer usable program code to, when executed by the processor, receive a number of identified content objects; and
computer usable program code to, when executed by a processor, identify a number of content objects associated within the media instance.
